(19) United States
(12) Patent Application Publication
(10) Pub. No.: US 2025/0253380 A1
(43) Pub. Date: Aug. 7, 2025

(54) CONFIGURATION CHANGER MECHANISM, CARRIER DEVICES, AND SYSTEM FOR PROCESSING POUCH BATTERY CELL HOUSINGS

(71) Applicant: MB Automation GmbH & Co. KG, Roding (DE)

(72) Inventors: Kostka Tomas, Povazska Bystrica (SK); Philipp Seppenhauser, Worth an der Donau (DE)

(21) Appl. No.: 18/856,166

(22) PCT Filed: Apr. 6, 2023
(86) PCT No.: PCT/EP2023/059263

§ 371 Date: Dec. 10, 2024

(30) Foreign Application Priority Data
Apr. 14, 2022 (DE) 102022109229.1

(51) Int. Cl. H01M 10/04; H01M 50/211; H01M 50/256; H01M 50/609

(52) U.S. Cl. CPC H01M 10/0404; H01M 50/211; H01M 50/256; H01M 50/609

(57) ABSTRACT

A configuration converter mechanism includes a locking tensioning mechanism which has a first and a second partial region. The first partial region is supported so as to be movable, by way of a translatory movement, with respect to the second partial region. The second partial region is supported so as to be movable, by way of a rotational movement, with respect to the first partial region about a first axis of rotation and, as part of this, can be transferred, by movements which include a rotation about the first axis of rotation, between different rest positions of the second partial region, which follow one another along a fixed direction of rotation and each of which are mechanically stable. The locking tensioning mechanism is set up to convert a translatory movement of the first partial region into a corresponding movement of the second partial region by means of a force coupling between the two partial regions, which movement of the second partial region.

### CROSS-REFERENCE TO RELATED APPLICATIONS

This application is a national phase entry of, and claims priority to, International Application No. PCT/EP2023/059263, filed Apr. 6, 2023, which claims priority to German Patent Application No. 10 2022 109 229.1, filed Apr. 14, 2022. The above-mentioned patent applications are incorporated herein by reference in their entireties.

### TECHNICAL FIELD

This application generally relates to a configuration converter mechanism for transferring a mechanical component, which may have different mechanical configurations, between these configurations. In particular, this application is also in the field of battery technology and further relates to a carrier device which is equipped with the configuration converter mechanism for carrying a pouch battery cell housing during a process for manufacturing a pouch battery cell, a workpiece carrier which is equipped with a plurality of such carrier devices for simultaneously carrying a plurality of pouch battery cell housings during a process for the manufacture of a plurality of pouch battery cells, in particular during a process for the simultaneous manufacture of a plurality of pouch battery cells, as well as finally a system for processing a plurality of pouch battery cells within the framework of such a process.

### BACKGROUND

In the field of mechanics, a wide variety of converter types are known, in particular force converters, which, depending on their type, can be used to convert a force or a kinetic variable into another mechanical variable, such as for example a torque, or another kinetic variable, such as a changed speed or an acceleration of a body. In particular, transmission devices are converters in the aforementioned sense.

In the field of battery technology, in particular in the field of vehicle batteries for hybrid electric vehicles (HEV) or battery electric vehicles (BEV), in particular “pouch battery cells”, as they are referred to, or “pouch cells” for short, are known as a type of construction for battery cells, in particular lithium ion battery cells, in addition to other type of construction. In this context, a pouch cell is a battery cell with a structure in the form of a pouch. In this context, the electrodes, the separator and the electrolyte of the cell are accommodated in a flexible, sealed pouch. In many cases, a liquid electrolyte is used as the electrolyte, which must be filled into the pouch during the course of the production of the pouch cell before it is sealed, i.e. permanently closed.

### SUMMARY

Thus, it would be desirable to provide improved devices and systems with which a process for producing pouch cells, in particular for filling them with liquid electrolyte and subsequently sealing them, can be carried out efficiently, in particular with a high throughput. In particular in this context, a suitable configuration converter mechanism is also to be provided which, when it is used as a component of the devices and systems mentioned above, contributes to solving the technical problems noted above.

A first set of embodiments disclosed herein relates to a configuration converter mechanism for a mechanical component. The configuration converter mechanism comprises:
(i) a locking tensioning mechanism which comprises (i-1) a first partial region and (i-2) a second partial region, wherein the first partial region is supported so as to be movable, by way of a translatory movement (in particular along a single direction of translation), with respect to the second partial region. The second partial region is supported so as to be movable, by way of a rotational movement, with respect to the first partial region about a first axis of rotation and, as part of this, can be transferred, by movements which include a rotation about the first axis of rotation, between different rest positions of the second partial region, which follow one another along a fixed direction of rotation and each of which are mechanically stable. In this context, the first axis of rotation can in particular coincide with the direction of the translation or run parallel to it. The locking tensioning mechanism is set up to convert a translatory movement of the first partial region brought about by the action of an external force on the first partial region into a corresponding movement of the second partial region by a force coupling between the two partial regions, which movement of the second partial region is a rotation about the first axis of rotation in the fixed direction of rotation or which comprises, as a movement component, a rotation about the first axis of rotation in the fixed direction of rotation, and which transfers the second partial region from its current rest position into a subsequent one of the rest positions in accordance with the direction of rotation; and
(ii) a component which can be transferred between different mechanical configurations. The component is coupled to the second partial region in a force-coupling manner in such a way that the transfer of the second partial region between two different successive rest positions brought about by the movement of the first partial region transfers the component between two different mechanical configurations of the component which correspond to the two successive rest positions of the second partial region by carrying out a movement of at least one portion of the component, which is a rotation about a second axis of rotation which is different from the first axis of rotation, or which comprises, as a movement component, a rotation about a second axis of rotation which is different from the first axis of rotation.

The term “locking tensioning mechanism”, as used herein, is intended to be understood to mean in particular a subtype of a tensioning mechanism, whereby tensioning mechanisms are transmission devices (or mechanisms) with springs that can assume two stable positions and maintain these without any external forces acting on them. The particular subtype of the “locking tensioning mechanism” is characterized by the fact that a transition from a first position, tensioned by a spring, to a less tensioned other position can be triggered by releasing a locking member. One example is a ballpoint pen with a release button. In the case of a ballpoint pen with a push button at the free end, both settings (tensioned, ready to write; less tensioned, reservoir retracted) are brought about by alternately pressing the button.

The term “mechanically stable rest position”, as used herein, is intended to be understood to mean in particular a position of a body, in the present document in particular of a partial region of the locking tensioning mechanism, in which the body is in a stable equilibrium, so that the body returns to its original position corresponding to the rest position after a perturbation has been applied (at least when the perturbation is small).

The term “mechanical configuration” or, for short, “configuration” of a component, as used herein, is intended to be understood to mean a specific spatial arrangement of the component. Such a spatial arrangement can relate in particular to the component as a whole and can be described using up to six degrees of freedom (three each for specifying the position and orientation). However, the arrangement can instead or additionally also refer to the spatial (absolute or relative) arrangement of different portions or parts of the component that can move relative to each other. Thus, for example, a pocket knife (as an analogy), depending on the number of blades or tools that can be folded out, even if it is stationary and held in a fixed orientation, sometimes has a large number of different configurations, depending on which of the blades or tools is/are folded out or is/are not currently folded out.

The terms “encompasses”, “contains”, “includes”, “comprises”, “has”, “with”, as they may be used herein, or any other variation of these, are intended to cover an inclusion which is not exclusive. Accordingly, for example, a method or a device which encompasses or comprises a list of elements is not necessarily limited to those elements, but may include other elements which are not explicitly listed or which inherently form part of such a method or device.

Further, unless expressly stated to the contrary, “or” refers to an inclusive “or” and not to an exclusive “or”. For example, a condition A or B is satisfied by any one of the following conditions: A is true (or present) and B is false (or not present), A is false (or not present) and B is true (or present), and both A and B are true (or present).

The terms “a” or “an”, as they are used herein, are defined in the sense of “one or more”. The terms “another” and “a further” as well as any other variant thereof are to be understood in the sense of “at least one further”.

The term “a plurality of”, as it may be used herein, is to be understood in the sense of “two or more”.

The terms “configured to” or “set up to” fulfil a particular function (and variations of these terms, respectively), as they may be used herein, are intended to be understood to mean that the respective device or component thereof is already present in a configuration or with a setting in such a way that it can perform the function, or that it can at least be adjusted—i. e. that it can be configured-to perform the function after appropriate adjustment. In this context, the configuration can be carried out, for example, by a corresponding setting of parameters of a process sequence or of switches or the like, for activating or deactivating functionalities and/or settings. In particular, the device can have several predetermined configurations or modes of operation, so that the configuring can be carried out by selecting one of these configurations or modes of operation.

The configuration converter in accordance with the first set of embodiments can be constructed in particular as a purely passive converter which requires an externally applied force acting on it in order to actuate it. It can therefore also be used in particular where no power supply is available for it, such as for example as part of a (machine) assembly which can be used in a mobile manner, such as the workpiece carrier described below.

The use of the combination of the particular locking tensioning mechanism and the component coupled to it enables the configuration converter to convert an externally applied force acting on the first partial region in a direction of translation in such a way that this results in a rotation of the component about its (second) axis of rotation, which is different from the direction of translation. In other words, a conversion from a translation to a rotation takes place, the axis of rotation of which can essentially be freely selected. In addition, the configuration converter is able to carry out this conversion in such a way that, after each actuation, a respective subsequent, mechanically stable rest position of the configuration converter and thus also of the component is achieved. This means that the position of the component can be gradually transferred between its different rest positions by a respective actuation of the configuration converter, whereby the component remains stable in each of these positions in the absence of any actuation and is effectively “locked in”.

In the following, various example embodiments of the configuration converter will first be described, each of which, as far as this is not expressly excluded or technically impossible, can be combined, in any desired manner, with one another as well as with the further, other embodiments described herein.

In some embodiments, the locking tensioning mechanism is furthermore set up in such a way that, for each of the rest positions of the second partial region, there is a corresponding mechanically stable rest position of the first partial region, in which the first partial region is held due to the force coupling between the two partial regions when the second partial region is in its corresponding rest position, wherein the rest positions of the first partial region differ from one another for different corresponding rest positions of the second partial region. In this way, corresponding rest positions are also provided for the first partial region with regard to its possible translatory movement, which corresponding rest positions can be used in particular to also bring the first partial region into a desired position and to keep it stable there, in dependence upon the configuration and thus the rest position. For example, depending on the rest position, the first partial region can thus be brought into a position where it clears a certain spatial region, for example in order to make room for a tool or another component of a device, or however—on the contrary—to block it (for example so as to serve as a stop for a movement of another component).

In some embodiments, the locking tensioning mechanism comprises:
(i) the first partial region, wherein this is constructed in a tubular form, in particular in the form of a hollow cylinder, with an interior space of the tubular which interior space extends along the direction of translation;
(ii) the second partial region, wherein this comprises a wing arrangement with at least one wing member which extends transversely to the direction of translation;
(iii) a motion link body (25) having a tubular form, in particular the form of a hollow cylinder, in which the first partial region (15) is supported so as to be movable in a translatory manner along a direction of translation which coincides with the first axis of rotation, wherein
   (iii-1) a groove or a slot-shaped opening in a wall of the motion link body cooperates with a lateral projection of the first partial region along the direction of translation in accordance with the principle of a motion link guide;
   (iii-2) the motion link body has a sawtooth-like contour at its end which faces towards the second partial region, wherein the minima of the sawtooth-like contour lying between each two adjacent teeth of the contour define the rest positions of the second partial region;
(iv) a shaft which is supported in the interior space of the tubular of the first portion, which shaft is force-coupled both to the second portion and to the component, for which purpose in particular a second spring may be present, in order to convey the force coupling between the two partial regions along the direction of translation; and
(v) a (first) spring in order to press the second partial region with its wing arrangement against the sawtooth-like contour of the motion link body.

In this context, the locking tensioning mechanism is configured in such a way that, when an external force acts on the first partial region along the direction of translation, this partial region, guided by the motion link guide with the shaft as a conveyor of the force, displaces the second partial region along the direction of translation against the spring force of the (first) spring, in order to transfer the wing arrangement out of a rest position defined by the contour and then, after the external force has ceased, due to a rotational movement of the second partial region caused by the interaction of the wing arrangement with the sawtooth-like contour, as well as the spring force of the (first) spring, into a subsequent rest position of the second partial region along the direction of rotation, which subsequent rest position corresponds to a corresponding position of the shaft along the direction of translation and thus to a configuration of the component corresponding to this position.

This particular type of construction of the configuration converter mechanism represents a particularly space-saving solution, in which a translatory mobility of the first partial region along a single direction of translation is sufficient. In this context, both the first and the second partial regions can each have rest positions, corresponding to one another, at different positions along the direction of translation, whereby the rest positions of the second partial region are transferred to the component into corresponding rest positions of the component by a corresponding coupling by the shaft, so that a rotation about the second axis of rotation takes place in the course of the transition between the rest positions of the component. Thus, a translatory movement of the first partial region in only one dimension caused by an external force can in particular be converted into a movement of the component which is a rotation about the second axis of rotation or at least comprises a movement component about the second axis of rotation (possibly in addition to at least one other movement component, in particular a translatory movement component).

In some embodiments, this configuration converter mechanism further comprises a second spring in order for the force coupling between the first partial region and the shaft to be provided through the second spring along the direction of translation. Due to the spring effect of the second spring, this force coupling is not rigid but is more or less damped depending on the spring hardness, so that movements of the shaft can be carried out by this force coupling which in particular have a low level of jerkiness or are even free of any jerks.

In some embodiments, this configuration converter mechanism further comprises a housing for accommodating the locking tensioning mechanism, at least in part. In particular, the housing can serve to provide protection for the configuration converter mechanism as a whole or for parts thereof, in particular the locking tensioning mechanism or parts thereof, against undesirable external physical, chemical or biological influences, such as for example mechanical influences or chemical influences caused by liquids, in particular electrolyte liquids in the case of application in the field of battery cell production.

In this context, the housing may in particular comprise: (i) a first housing part with a pot-shaped or tubular base body, in particular a base body in the form of a hollow cylinder, in the interior space of which the locking tensioning mechanism is accommodated, at least in part, and which base body is firmly connected to the motion link body; and (ii) a second housing part which is connected to the first partial region in order to couple the external force to the first partial region and which second housing part surrounds the first housing part, at least in part, in such a way that the second housing part can be displaced with respect to the first housing part along the direction of translation. In particular, such a housing has the advantage that it can adjust its overall dimensions in dependence upon the current state of the configuration converter mechanism in order to follow the relative movement of the two partial regions. In this way, each of the two housing parts can also be specially adapted to its functions, in particular the first housing part as a protective cover and the second housing part as a basic structure for carrying and fixing the entire configuration converter mechanism.

The features and advantages explained in relation to the first set of embodiments of the invention also apply, mutatis mutandis, to the further sets of embodiments explained below.

A second set of embodiments disclosed herein relates to a carrier device for carrying a pouch battery cell housing during a process of manufacturing a pouch battery cell. The carrier device comprises:
(i) a holder for holding the pouch battery cell housing; and
(ii) a configuration converter mechanism in accordance with the first set of embodiments.

In this context, the component of the configuration converter mechanism has an engagement mechanism which, in one configuration, has a loading and an unloading position and, in another configuration, a filling position, between which it can be transferred by the configuration converter mechanism. In the loading and unloading position, loading and unloading of the holder with the pouch battery cell housing is made possible by clearing a loading and unloading path for the pouch battery cell housing that is required for this purpose. In the filling position, at least one engagement element of the engagement mechanism is introduced into the loading and unloading path in such a way that the engagement element engages, or can engage, in a filling opening of a pouch battery cell housing that may be held by the holder, in particular in order to keep the filling opening open.

Such a carrier device can therefore, in particular, be used firstly to hold a pouch battery cell housing, which pouch battery cell housing is to be processed, in a defined position by the holder, in particular to fix it in place, and secondly to implement, in a targeted manner and by the configuration converter mechanism, different positions which are used in different phases of a process of manufacturing a pouch cell, as mechanically stable positions in each case. In this way it is in particular possible to ensure, in the filling position, that the filling opening of a pouch battery cell housing to be filled with electrolyte liquid is open during this filling process. In this way, on the one hand, this can prevent the electrolyte liquid from unintentionally reaching areas that it is not desired to reach, in particular outside the pouch battery cell housing, due to the filling opening not being open or not being sufficiently open. However, on the other hand, potential damage to the pouch battery cell housing by a filling tool, such as for example a needle-shaped filling lance, can also be prevented.

In the following, various example embodiments of the carrier device will first be described, each of which can, as far as this is not expressly excluded or technically impossible, be combined with one another as well as with the other embodiments in any desired manner.

In some embodiments, the engagement mechanism furthermore has a third configuration and the configuration converter mechanism has a third rest position of the second partial region, which third rest position corresponds to the third configuration. In this context, in the third configuration, the engagement mechanism has a third position that is different, on the one hand, from the loading and unloading position and, on the other hand, from the filling position, so that when the configuration converter mechanism is actuated at least three times, these three positions, optionally including one or more yet further configurations, of the engagement mechanism are passed through sequentially, in particular in the sense of a closed loop (circular process).

In some embodiments, in the third configuration, the engagement mechanism assumes a position in which the or each engagement element is moved out of the loading and unloading path and exposes the filling opening of a pouch battery cell housing which may be held in the holder. This position can be used in particular as a position in which the filling opening is sealed in the filling position after a preceding filling of the pouch battery cell housing. For this purpose, as a rule, a corresponding sealing tool needs to be brought to the filling opening or the area of the pouch battery cell housing surrounding it, for which the clearing of the loading and unloading path on the one hand and of the filling opening on the other hand can be used, or it can represent prerequisites, in the course of the transfer of the engagement mechanism to the third configuration.

In some embodiments, the engagement mechanism comprises a crossbar which can be transferred between the different configurations of the engagement mechanism by the configuration converter mechanism and from which crossbar the engagement element or elements extend as projections, in particular with circular or elliptical cross-sections. This has the advantage that all engagement elements can be moved simultaneously, for which purpose only the crossbar needs to be moved accordingly via the configuration converter mechanism. In addition, the crossbar can serve as a mechanically robust base structure for the arrangement of the engagement elements.

In some embodiments, the engagement mechanism comprises at least two engagement elements, between which there is a recess or opening in the crossbar, through which, in the filling position of the component, an access to the filling opening of the pouch battery cell housing, which pouch battery cell housing may be held in the holder, is enabled. This can be used in particular to fill the pouch battery cell housing with a liquid, in particular an electrolyte liquid, by a filling lance that can be guided through the recess or opening. In this context, the recess or opening can also provide additional (mechanical) protection against any possible damage to the pouch battery cell housing caused by the filling lance.

In some embodiments, the holder has an adjustment option in order to adapt it to different formats of pouch battery cell housings. In this way it is possible to ensure that a respective pouch battery cell housing is always held in the holder in an optimum manner and in a fixed position, even with changing formats. This therefore also serves in particular to increase process reliability and yield optimization.

A third set of embodiments disclosed herein relates to a workpiece carrier for simultaneously carrying a plurality N of pouch battery cell housings during a process for the production of up to N pouch battery cells, in particular a simultaneous production of up to N pouch battery cells. In this context, the carrier device comprises a carrier structure which carries N of the aforementioned devices fixed thereto or integrally formed therewith, these devices being in accordance with the second set of embodiments, in such a way that these devices can be operated simultaneously, in order to carry up to N pouch battery cell housings, which may be held by a respective holder of an associated one of the devices, during the process. In particular, the carrier structure may be formed as a (rigid) support plate or may include such a plate.

A fourth set of embodiments disclosed herein relates to a system for processing a plurality of pouch battery cell housings within the framework of a process for manufacturing pouch battery cells. The system comprises a plurality of processing stations to be passed through sequentially for processing the pouch battery cell housings.

The system is further configured to use a workpiece carrier in accordance with the third set of embodiments both during processing of the pouch battery cell housings in the individual processing stations, and for transferring the pouch battery cell housings between the processing stations within the framework of the process of handling the pouch battery cell housings. One or more workpiece carriers in accordance with the third set of embodiments may in particular themselves each be a (movable) component of the system.

In the following, various example embodiments of the system are first described, each of which can, as far as this is not expressly excluded or technically impossible, be combined with one another as well as with the other embodiments in any desired manner.

In some embodiments, at least one of the processing stations comprises one or more actuators by which, when it/they is/are actuated once or several times, a respective force can be exerted onto the respective first partial regions of each of the carrier devices of the workpiece carrier in order to set a predetermined configuration, assigned to the respective processing station, of the respective engagement mechanism of each of the carrier devices of the workpiece carrier. Accordingly, the workpiece carrier can be constructed as a purely passive component, i.e. without having to have its own power supply or its own drive. Instead, it is possible in this way that the drive which is required to transfer the workpiece carrier or its engagement mechanisms of the carrier devices of the workpiece carrier between the different configurations or positions is provided solely by the processing station at which the workpiece carrier is currently located. In particular, this also facilitates the transport of the workpiece carrier from processing station to processing station, since, apart from the energy to be provided by the system itself for transportation, the workpiece carrier does not require its own power supply, and such a power supply does not need to be maintained.

In some embodiments, the at least one of these processing stations, which may in particular be a processing station for loading and unloading pouch battery cell housings into, or out of, the holders of the carrier devices of the workpiece carrier, comprises a suction mechanism. This is configured, while the workpiece carrier is located at or in this processing station, to apply suction to at least one side wall of a pouch battery cell housing which may be present in the holder of one of the carrier devices, in order to open, or keep open, a filling opening of the pouch battery cell housing, so that by actuating the actuator or actuators, the engagement mechanism of the carrier device can be brought into a position in which at least one of the engagement elements of the engagement mechanism engages, or can engage, in the filling opening.

In some embodiments, one of the processing stations is configured for loading and/or unloading pouch battery cell housings respectively into, and/or out of, the holders of the carrier devices of the workpiece carrier while the engagement mechanisms of the carrier devices are respectively in the loading and unloading position. Since the respective loading and unloading path of the carrier devices is cleared in the loading and unloading position, loading and unloading of the workpiece carrier with pouch battery cell housings can be carried out without any problems, in particular while excluding or at least minimizing the risk of damage due to unintended contact of the pouch battery cell housings with system components, even if tolerances regarding the handling of the pouch battery cell housings during loading and unloading might have to be observed.

In some embodiments, at least one of the processing stations is configured to fill any pouch battery cell housings which may be present in the workpiece carrier, which are each held by the holder of an associated one of the carrier devices of the workpiece carrier, with an electrolyte liquid, in particular with the aid of a filling lance, while the engagement mechanisms of the carrier devices of the workpiece carrier are in their respective filling position. The system can therefore be used to fill a plurality of pouch battery cell housings which are present in the workpiece carrier, in particular simultaneously and thus in a manner which increases throughput. In particular, this filling process can be advantageously combined with the suction mechanism mentioned above. In addition, when, as part of this, the engagement mechanisms of the carrier devices of the workpiece carrier are in the filling position, it is ensured that the filling openings of the pouch battery cell housings are in an open state and are kept in the open state while filling takes place.

In some embodiments, at least one of the processing stations is configured to close any pouch battery cell housings which may be present in the workpiece carrier and which are each held by the holder of an associated one of the carrier devices of the workpiece carrier, after they have previously been filled with an electrolyte liquid, in particular to seal their filling openings, while the engagement mechanisms of the carrier devices of the workpiece carrier are each in a position (closing position) which is different from the filling position. The system is therefore capable of carrying out both a filling operation and subsequently a closing operation of the pouch battery cell housings. Since different tools or components of the system can be used for this purpose, which can have different dimensions, shapes and/or arrangements and movement trajectories (e.g. travel paths) within the system, it can be advantageous to provide, in addition to a loading and unloading position and a filling position, one or more other positions for the engagement mechanisms of the carrier devices as well. One example of this is the closing position mentioned above. However, it is also conceivable that the closing position coincides with the loading and unloading position and differs only from the filling position in order to thus make the inlet openings of the pouch battery cell housings accessible for the system components or tools which are used to close them.

The features and advantages which have been explained in relation to the first set of embodiments of the invention also apply accordingly to the further sets of embodiments of the invention.

### BRIEF DESCRIPTION OF THE DRAWINGS

Further advantages, features and possible applications of the present invention become clear from the following detailed description in conjunction with the figures. The accompanying drawings, which are incorporated in and constitute a part of this specification, illustrate one of more embodiments of the invention and, together with the general description given above and the detailed description given below, explain the one or more embodiments of the invention.

FIGS. 1A-1C are a schematic side view and two cross-sectional views of a configuration converter mechanism, in particular of a locking tensioning mechanism, in accordance with an example embodiment.

FIGS. 2A and 2B are perspective sectional views of the locking tensioning mechanism of FIG. 1 which are rotated relative to each other by an angle of 90° about the longitudinal axis of the locking tensioning mechanism.

FIG. 3 is a schematic view of a number of individual components of the locking tensioning mechanism shown in FIGS. 1 and 2.

FIGS. 4A-4F are side views showing a sequence of different positions of the locking tensioning mechanism shown in FIGS. 1 and 2, which sequence can be followed in a loop-like manner.

FIG. 5 is a side view of a carrier device in accordance with an example embodiment.

FIG. 6 is a perspective view of a workpiece carrier in accordance with an example embodiment.

FIG. 7 is a block diagram of a system for processing a plurality of pouch battery cell housings in accordance with an example embodiment.

In the figures—unless it is stated otherwise—identical reference signs denote identical, similar or corresponding elements. The elements which are shown in the figures are not necessarily shown to scale. Rather, the various elements which are shown in the figures are depicted in such a way that their function and general purpose can be understood by a person skilled in the art. Any connections and couplings between functional units and elements and which are shown in the figures can also be implemented as indirect connections or couplings, unless expressly stated otherwise.

### DETAILED DESCRIPTION

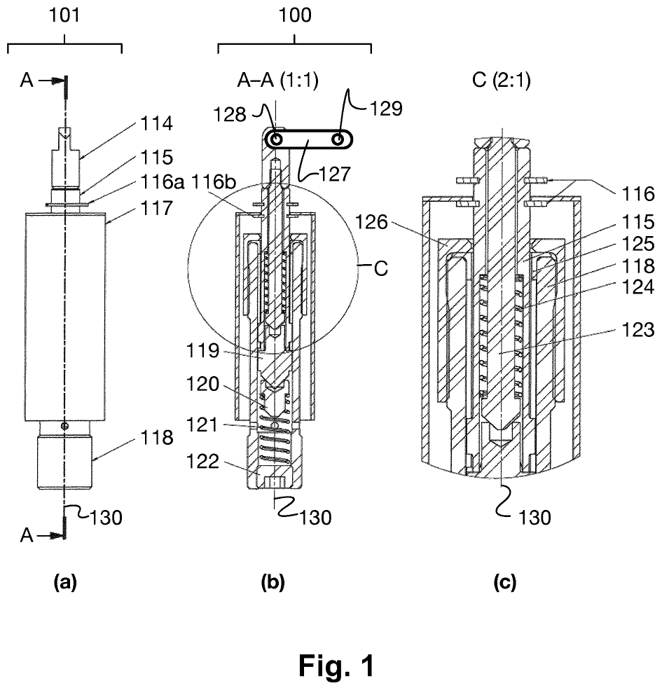

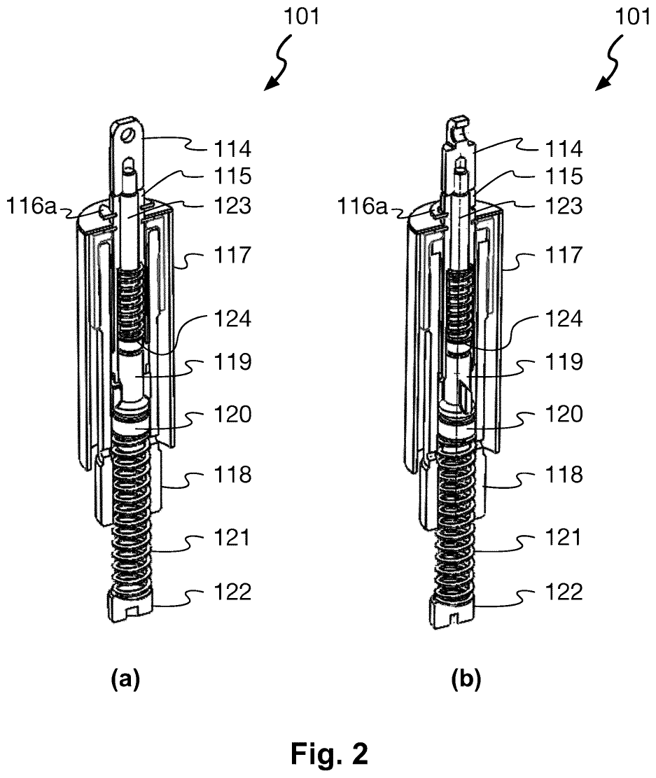

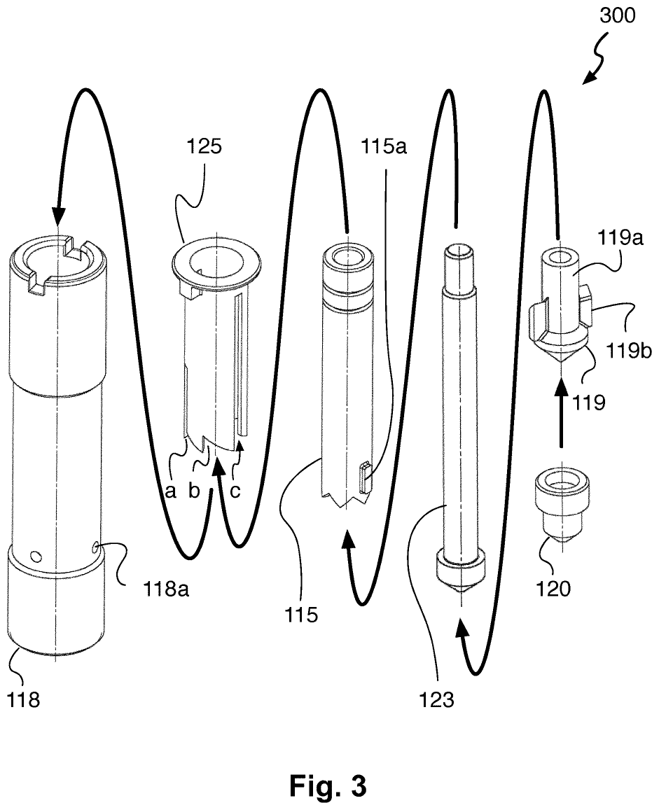

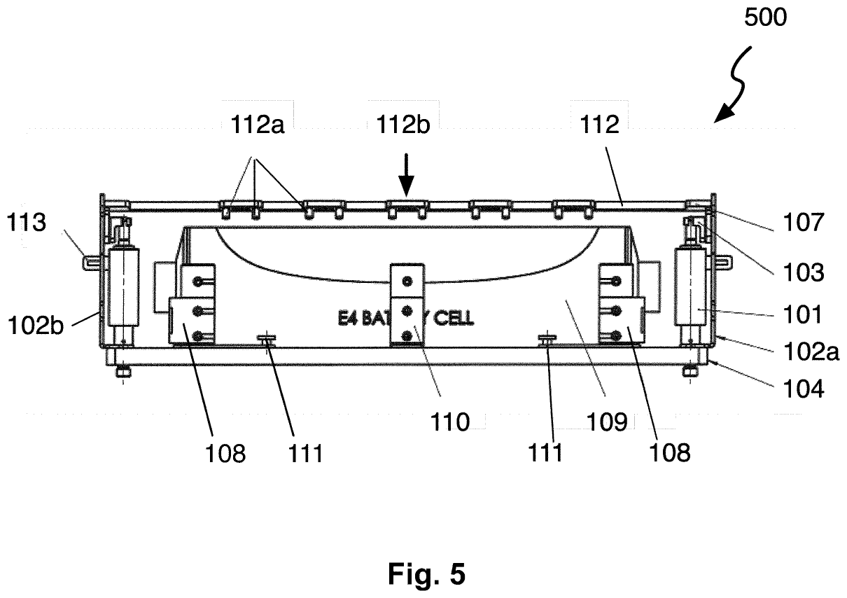

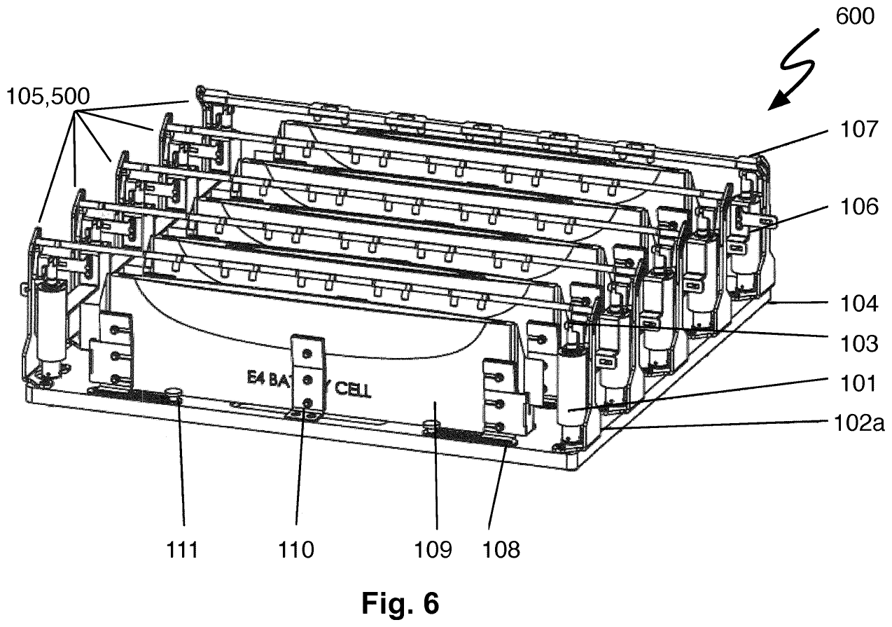

FIG. 1 shows various detailed views of a locking tensioning mechanism 101 of a configuration converter mechanism 100, whereby, however, except in FIG. 1B, the “component” 127 of the configuration converter mechanism 100, which component 127 has been mentioned above and which can be transferred between different configurations, is not shown here, and also not in FIGS. 2A to 4F, in the interest of a clearer representation (it is, on the other hand, shown as a particular embodiment “engagement mechanism” in FIGS. 5 and 6). In particular, FIG. 1A shows a side view, FIG. 1B a cross-sectional view along the sectional line A-A of FIG. 1A, and FIG. 1C shows an enlarged portion C of FIG. 1B. The same locking tensioning mechanism 101 is shown in a perspective view in FIGS. 2A and 2B. Detailed views 300 of selected individual components of the locking tensioning mechanism 101 are shown in FIG. 3. Accordingly, the explanations following below refer equally to FIGS. 1A to 3. Insofar as the terms “above” or “below” (or variations thereof) are used here, they refer to the specific representation in the respective figures.

The configuration converter mechanism 100 has, with respect to its locking tensioning mechanism 101, a structure in which several of its components (see FIG. 3) are arranged nested within one another and together form the locking tensioning mechanism 101. In the first instance, this locking tensioning mechanism 101 has a base body 118 which, on the one hand, forms a central upright structure of the locking tensioning mechanism 101 and, at the same time, serves to fasten it to an external carrier structure, in particular a carrier device 500 of FIG. 5 and/or a workpiece carrier 600 of FIG. 6) in accordance with the second or third embodiment. For this purpose, the locking tensioning mechanism 101 can in particular have (not shown) a screw thread or a different fastening mechanism (for example in the sense of a bayonet lock or a snap-in connection) at its bottom end (in FIGS. 1A to 3, this is its respective lower end, which is also referred to here as “bottom”, for the purpose of there being a simple way of referring to it). The base body 118 also represents a first housing part of a multi-piece housing of the locking tensioning mechanism 101, wherein the housing additionally has a second housing part 117, which can in particular have a tubular shape or a pot shape, and in the interior space of which further components of the locking tensioning mechanism 101 are arranged so as to be protected from outside influences.

The base body 118 or its interior space is at least partially closed at its bottom end by a first (lower) end piece 122 and at its opposite end by a second (upper) end piece 126. The use of such end pieces 122, 126, which are not integrally formed with the base body 118, is advantageous in particular with regard to the assembly of the locking tensioning mechanism 101 in the course of its manufacture, in order for the further components of the locking tensioning mechanism 101 which are intended to be arranged in the interior space of the base body 118 to be able to be inserted before the base body 118 is closed by the end pieces 122 and 126. In addition, one or more air holes 118a can be formed in the wall of the base body in order to enable a rapid exchange of air in the context of a movement of components of the locking tensioning mechanism 101 located in the base body in order to reduce the build-up of unwelcome differences in air pressure.

A tubular motion link body 125, in particular a motion link body 125 which is substantially of the shape of a hollow cylinder, is arranged in the base body 118 at its (upper) end remote from the bottom. Partially inserted into the interior space of the motion link body 125 is a tubular body, in particular a body which is substantially of the shape of a hollow cylinder, which is referred to here as the “first partial region” 115 of the locking tensioning mechanism 101, this body being supported in such a way that it can carry out translatory movements along the longitudinal direction 130 of the base body. In this context, a groove 125c in a wall of the motion link body 125 interacts with a lateral projection 115a of the first partial region 115 in accordance with the principle of a motion link guide along the longitudinal direction 130 as the direction of translation. At its (lower) end facing towards the second partial region 119, the motion link body 125 has a sawtooth-like contour, the minima 125a, 125b and 125c (which is at the same time the groove mentioned above) of which each respectively lie between two adjacent teeth of the contour.

In this context, the first partial region 115 is also inserted into the interior space of the base body 118 in such a way that it extends through the second (upper) end piece of the base body 118 and the second housing part 117 of the base body 118 into the interior space of the base body 118 and that it is supported there in such a way that it can carry out translatory movements along the longitudinal direction 130. At the first partial region 115, a sealing ring 116a (which seals in particular against electrolyte liquid in the application case of FIGS. 5 and 6) and a stop member 116 b, which couples the first partial region 115 to the second housing part 117, are located on the two sides of the second housing part 117. The stop member 116 b also has the task of transmitting an external force acting on the second housing part 117 in the direction of the first spring 121 to the first partial region 115 in order to actuate the locking tensioning mechanism 101. For this purpose, the second housing part 117 can, in particular on its outer wall or its (upper) end face, have a projection or the like, on which the external force can act.

A rod-shaped shaft 123 is supported in the interior space of the first partial region 115 in such a way that it can move along its longitudinal direction 130. As part of this support, a second spring 124 is provided, which provides a spring-loaded force coupling between the first partial region 115 and the shaft 123 along the common longitudinal direction 130, so that a transmission of force from the first partial region 115 to the shaft 123, and vice versa, can take place along the common longitudinal direction 130. At its end remote from the bottom, the shaft 123 protrudes from the second housing part 117 and the first partial region 115.

At the end of the shaft 123 remote from the bottom, which protrudes from the partial region 115 at the end thereof remote from the bottom, a connecting member 114 may, in particular, be attached to the shaft 123 or formed as an integral part of the shaft 123, as shown. The component 127 of the configuration converter mechanism 100 can be coupled to the connecting member 114 (cf. FIG. 1B) in order to transfer the component 127 between its different mechanical configurations upon actuation of the configuration converter mechanism 100 and a resulting movement, along the longitudinal direction 130, of the shaft 123 and thus of the connecting member 114 attached thereto. In the simple example of FIG. 1B, the component 127 is a simple lever which is coupled to the connecting member 114 via a pivot axis 128 and which is pivotable about a (first) pivot axis 129 which runs at an angle with respect to the longitudinal direction 130, in particular (as shown) orthogonal to the longitudinal direction 130, whereby different configurations of the component 127 have different pivot angles.

At its bottom end, which may in particular be constructed in a conical or frustoconical shape, the shaft 123 is force-coupled indirectly via a further component, which is referred to here as “second partial region” 119, and optionally additionally (as shown), in particular for the purpose of reducing friction, by a further intermediate member 120 to a first spring 121 which is supported on the first end piece 122. The longitudinal directions of the first partial region 115, of the shaft 123 and of the springs 121 and/or 12 coincide (as shown) or are parallel to one another, so that, overall, the first partial region 115 is resiliently supported with respect to the bottom side by the spring 121 via the components 123, 124, 119 and 120 arranged in-between.

The spring 121 (which is also referred to herein as the “first spring”) is preferably stronger, i.e., for the same deflection, it has a greater spring force than the spring 124 (which is also referred to herein as the “second spring”). This ensures that, in the absence of an external force acting on the first partial region 115 and thus on the shaft 123 via the second spring 124, the first spring 121 can press the shaft 123 and the first partial region 115 against the action of the second spring 124 into their respective position remote from the bottom, in which the second spring 124 is compressed completely or at least to a certain degree (which depends on the ratio of the spring constants of the two springs).

The second partial region 119 has a guide member 119a, which, at least in part, is rod-shaped or tubular and, on the outside of which, a wing arrangement with at least one wing member 119b extending transversely to a longitudinal axis of the guide member is attached or formed integrally with the second partial region 119. The or each wing member 119b is chamfered on its side remote from the bottom in order to form an inclined sliding surface. The bottom end of the second partial region 119 may in particular be constructed in a conical or frustoconical shape in order to be able to couple in a centered and slip-resistant manner with an (upper) opening of the intermediate member 120, which may in particular have the shape of a circular area. However, the second partial region 119 is supported in such a way that it can rotate about the longitudinal direction 130, so that this forms an axis of rotation, which is referred to here as the “first axis of rotation”.

In this context, the wing arrangement 119b is configured in such a way that it can engage in the groove 125c, so that the groove 125 can act as a motion link guide also with respect to the second partial region when the orientation of the second partial region with respect to its axis of rotation is such that the wing member 119a can engage in the groove 125c. In other rotational positions, on the other hand, the wing member can in particular also come to rest in one of the further minima 125a or 125b of the sawtooth contour of the second partial region 119 if no external force acting against the first spring 121 acts on the first partial region 115. These positions of the second partial region 119 thus represent mechanically stable rest positions of the second partial region 119. Since the second partial region 119 is force-coupled to the shaft 123 and the positions of the minima 125 a,b,c differ along the longitudinal direction 130, these minima 125 a,b,c define, at the same time, corresponding rest positions of the shaft 123, of the connecting member 114 and of the component 127.

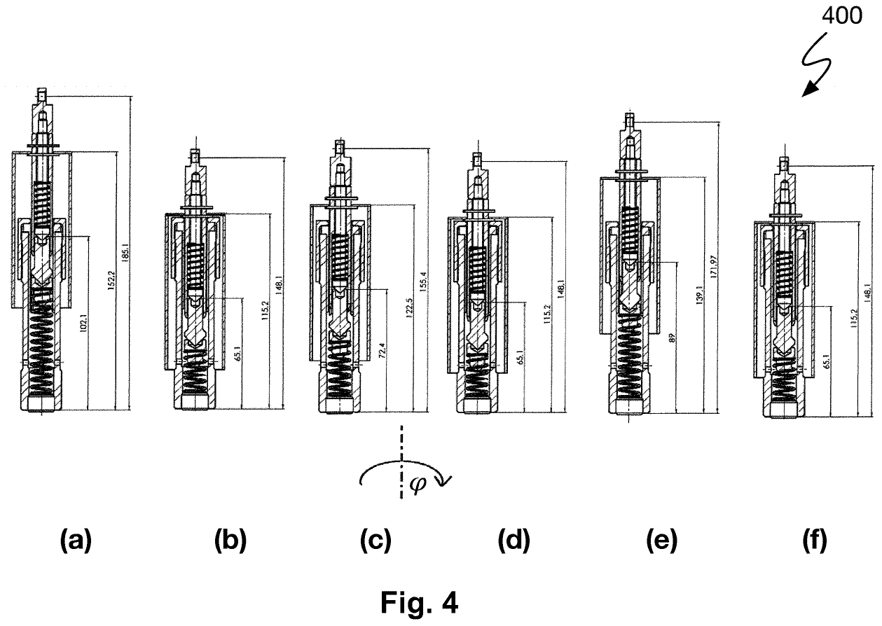

The operation of the configuration converter mechanism 100 can be described as follows with additional reference to FIGS. 4A-4F, in which a sequence 400 of different successive states of the locking tensioning mechanism 101 is illustrated.

When no external force acts on the first partial region 115, the locking tensioning mechanism 101 is in a first rest position defined by the current rotational position of the second partial region 119 and thus of its wing arrangement, which first rest position is maintained by the “strong” first spring 121. This rest position can correspond in particular, as is shown in FIG. 4A, to a rotational position of the second partial region in which the wing member 119b engages in the groove 125c, so that the spring 121 has its maximum possible deflection defined in particular by the length of the groove 125c and so that the shaft 123 thus assumes its position where the distance from the bottom of the base body is at a maximum.

If now, as is shown in FIG. 4B, an external force is applied to the second housing portion 117, either directly or indirectly, in order to actuate the configuration converter mechanism 100, which external force has a directional component along the longitudinal direction 130 towards the bottom of the base body 118, then this force or force component is transmitted to the first partial region 115 via the stop member 116 b so that the first partial region 115 is pressed towards the bottom and, in turn, transmits the force or force component to the second spring 124, at least in part. The spring 124 in turn acts as a conveyor of force and couples the force or force component to the shaft 123, which is thus pressed against the second partial region 119, which in turn presses on the intermediate member 120, which in turn presses on the first spring 121 and shortens and thus tensions it. In this position, the wing member 119b is not in any of the minima 125a, b, c so that no rest position has been reached. Rather, this state is a transitional position, as a rule a dynamic transitional position, which also would not be stable without the external force.

If the external force is now removed, as shown in FIG. 4C, or is reduced to a sufficient degree so that the spring force of the tensioned first spring 121 gains the upper hand, the coupled components intermediate member 120, second partial region 119 and shaft 123 are, as a result, pressed away from the bottom along the longitudinal direction against the (weaker) second spring 124. Thus, the wing arrangement or the wing member 119b comes into contact with the sawtooth-like contour of the motion link body 125. Due to the interaction of the contour, caused by the first spring 121, with the inclined sliding surface of the wing member 119b, which is now pressed onto it, more precisely onto a sliding surface of a sawtooth of the contour, a torque acting on the second partial region 119 is generated with respect to the first axis of rotation. As a result, the wing member slides along the sliding surface of the saw tooth while carrying out a rotation about the first axis of rotation until it reaches the minimum of the group of minima 125a, b, c which follows in the sliding direction, where a second rest position which is different from the first rest position is reached. It is mechanically stable even after the external force is removed and is maintained by the first spring 121.

Now, if another actuation of the configuration converter mechanism 100 or of the locking tensioning mechanism 101 takes place by an external force being applied again, the second rest position is exited again, as happened before with the first rest position, and an unstable intermediate position shown in FIG. 4D is reached, which corresponds to the position in FIG. 4B. If the force is then removed again or is reduced to a sufficient degree, the locking tensioning mechanism transitions, in the same way as has been described above for the transition between the first and the second rest positions, to a third rest position shown in FIG. 4E, which is different from the other two rest positions.

If yet another actuation of the configuration converter mechanism 100 or of the locking tensioning mechanism 101 subsequently takes place, the initial state from FIG. 4A, i.e. the first rest position, is reached again after passing through a further unstable intermediate position shown in FIG. 4F, which in turn corresponds to the position from FIG. 4B.

In FIG. 5, a carrier device 500 in accordance with an example embodiment of the present solution is illustrated. In particular, the carrier device 500 is configured to handle a pouch battery cell housing 109 during the manufacture of a pouch battery cell, in particular to hold it in a predetermined position. For this purpose, the carrier device 500 has a carrier structure 104, which can be constructed in particular as a rigid base plate 104 on which a holder is provided. The holder comprises, on the one hand, two outer holders 108 and, on the other hand, a central holder 110 located between these. A different number of central holders 110 is also conceivable.

In this context, the two outer holders 108 can be moved as regards their position relative to the central holder 110 and can be fixed in different positions, for example each with a respective fixing screw 111, so that an adaptation to at least two different formats of pouch battery cell housings 109 becomes possible. In this way, it becomes possible for the pouch battery cell housing 109 to be held in the holder in an optimal manner. Preferably, the holder is oriented in such a way that the pouch battery cell housing 109 is held therein substantially in such a way that its major surfaces are orthogonal to the base plate 104 and the pouch battery cell housing 109 can be loaded into, and unloaded from, the holder from an upper surface of the carrier device 500 opposite the base plate 104 along a substantially rectilinear loading and unloading path.

The carrier device 500 further includes an engagement mechanism which serves to hold open a filling opening of any pouch battery cell housing 109 which may be located in the holder during its processing.

For this purpose, the engagement mechanism has, among other things, two upright structures 102a and 102b which are mounted on the base plate 104 and which can extend relative thereto, in particular perpendicularly thereto. In this context, the upright structures 102a,b preferably have a height which exceeds that of a pouch battery cell housing 109 located in the holder. A guide groove is provided at the upper end of each of the upright structures, in which a crossbar 112 extending parallel to the base plate 104 is movably supported, which crossbar 112 is also a component of the engagement mechanism. In this context, the mobility of the crossbar 112, via a pivot mechanism 107, which can in particular have the respective guide groove in the upright structure 102a,b on both sides of the crossbar 112 and a respective guide element (e.g. projection) of the crossbar 112 running therein, is configured in such a way that a pivoting movement of the crossbar 112 can be carried out, which is composed of at least one translation and at least one rotation. More precisely, the mobility of the crossbar 112 is configured in such a way that it can assume different rest positions. In this context, a first rest position corresponds to a position of the crossbar 112 in which it clears the loading and unloading path, so that it does not stand in the way of loading and unloading of the holder with a pouch battery cell housing 109. This first rest position can therefore be referred to as a loading and unloading position.

In a second rest position, on the other hand, the crossbar 112 is pivoted over the holder in such a way that, when a pouch battery cell housing 109 is located in the holder and a filling opening of the pouch battery cell housing 109 is present on that side of the pouch battery cell housing 109 which is opposite the base plate 104 and this filling opening is open, engagement elements 112a which are provided on the crossbar 112 and which may in particular be peg-or pin-shaped, can engage in the filling opening in order to keep it in an open state. In this rest position, in particular a filling process of the pouch battery cell housing 109 with an electrolyte liquid can be carried out. This can be done in particular by one or more filling lances, which, for this purpose, are inserted into the open filling opening in order to deliver the electrolyte liquid into the interior of the pouch battery cell housing 109. Since, at the same time, the engagement elements 112a engage in the filling opening, the latter remains open in a stable manner, so that undesired damage to the pouch battery cell housing 109 by the filling lances and/or incorrect dispensing of the electrolyte liquid on the outside of the pouch battery cell housing 109 can be avoided with a high degree of certainty. The second rest position can therefore be referred to as a filling position.

Safety during filling can be further increased by providing a recess or opening 112b in the crossbar 112 at a suitable location, in particular between each two adjacent engagement elements 112a, through which recess or opening 112b a filling lance can be guided into the filling opening. In this way, a further protection factor results due to the thus additionally defined boundary conditions for the mobility of the filling lances.

Optionally, in particular a third rest position can also be provided, which differs from the first two rest positions. In this rest position, the crossbar 112 with the engaging elements 112a does indeed clear the loading and unloading path. However, it assumes a position which is different from the loading and unloading position, in which it clears the upper side of the pouch battery cell housing 109 with the filling opening for a tool for closing (sealing) the filling opening as well as at the same time a travel path for the tool. Such a third rest position, which can be referred to as a closing position, is therefore always useful or even necessary if the use of the tool for closing the filling opening is not also possible in the loading and unloading position of the engagement mechanism.

In order to transfer the engagement mechanism between its different rest positions, which, due to the different positions, also correspond to different mechanical configurations of the engagement mechanism, the carrier device 500 has at least one configuration converter mechanism 100 as shown in FIGS. 1A to 4F. If two configuration converter mechanisms 100 are provided, each of which is arranged adjacent to one of the upright structures 102a or 102b, they are each coupled with their connecting member 114 to the crossbar 112 via a connecting part 103, such as for example a lever, in order to be able to transfer the crossbar 112 between its three rest positions, whereby each of these rest positions corresponds to one of the associated rest positions of the locking tensioning mechanism 101 of the configuration converter mechanism 100 (as described above). The engagement mechanism thus assumes the role of the “component” of the configuration converter mechanism 100, analogous to the component 127 of FIG. 1B.

In addition, a position element may be provided on the carrier device 500, for example, as shown, on the upright structure 102b, which position element serves as a position marker for an external position sensor in order to enable the latter to determine the position of the carrier device 500 as accurately as possible.

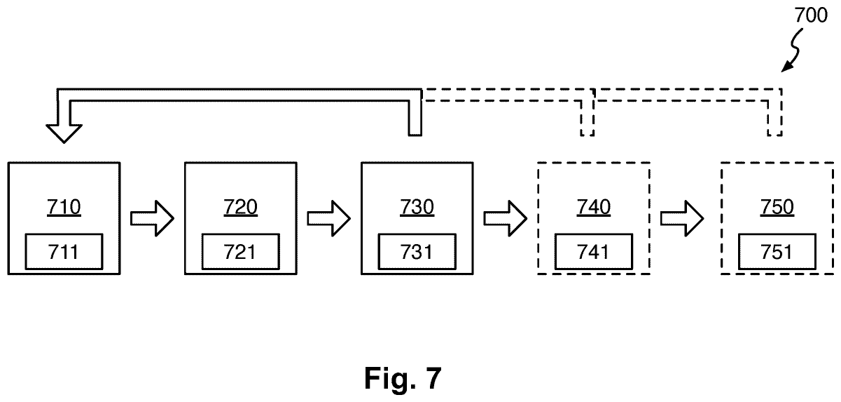

FIG. 6 illustrates a workpiece carrier 600 in accordance with an example embodiment of the present solution. The workpiece carrier 600 has a base plate 104, which can correspond to that of the carrier device 500 of FIG. 5. A plurality of carrier devices 105 are arranged parallel to one another on this base plate, in the present example five carrier devices 105, each of which can correspond in particular, as shown, to a carrier device 500 of FIG. 5. In this arrangement, in order to provide a particularly inaccessible contact surface for the external force which is required to actuate the configuration converter mechanism 100 of the respective carrier device 105, a respective position control member 106 is attached to each of the second housing parts 117 of the locking tensioning mechanisms 101 of the configuration converter mechanisms 100. In particular, this may be a plate-shaped projection on which an actuator of a processing system which uses the workpiece carrier 600 (see FIG. 7) can be placed in order to exert the external force.

The mode of operation of the workpiece carrier 600 substantially corresponds to the mode of operation of its individual carrier devices 500, as described above, whereby, however, the various carrier devices 105 can be operated in particular simultaneously, but optionally also at different times. Overall, the workpiece carrier 600 is a passive device, whereby the application of external forces on the locking tensioning mechanisms 101 of the configuration converter mechanisms 100 is required in order to operate the workpiece carrier 600. An advantage of the workpiece carrier 600 is in particular also the simplification of the handling of a plurality of pouch battery cell housings 109 in the context of a production of pouch battery cells.

In FIG. 7, a system 700 for processing a plurality of pouch battery cell housings 109, in particular for simultaneously processing a plurality of pouch battery cell housings 109, is illustrated, in accordance with an example embodiment of the present solution. The system 700 comprises a plurality of processing stations 710-730 which are passed through sequentially or in accordance with the principle of a closed loop as part of a process for manufacturing pouch battery cells, for which purpose a workpiece carrier 600 of FIG. 6 is used in order to handle a plurality of pouch battery cell housings 109 and to transport them between the individual processing stations 710 to 730. Further processing stations, such as the processing stations 740 and 750, which are shown in dashed lines, may also be provided which are passed through during processing.

A first processing station 710 is a loading station in which a number of pouch battery cell housings 109 that is greater than or equal to the number of carrier devices 105 on the workpiece carrier 600 are loaded onto the workpiece carrier 600. For this purpose, the loading station 710 may in particular have a corresponding robotic system. The pouch battery cell housings 109 already have a battery cell with at least one cathode, at least one anode and a separator located between them. In particular, the battery cell may be a lithium-ion pouch cell.

For the purpose of bringing the workpiece carrier 600 into its loading position, the loading station 710 has an actuator 711 which is suitably configured to actuate the configuration converter mechanisms 100 of the workpiece carrier 600 in order to initially bring the engagement mechanisms of its carrier devices 105 into their respective loading and unloading positions, so that the loading process can be carried out. The actuator 711 is further configured, for example via a corresponding controller, to bring the respective engagement mechanism of the carrier devices 105, by corresponding actuation of the configuration converter mechanisms 100, into their filling positions after loading of the carrier devices 105 has been completed, so that the engagement elements 112a can engage in the open filling openings of the respective pouch battery cell housings 109 in order to keep them open.

The system 700 further comprises at least one device, for example a plurality of conveyor belts (indicated here by arrows), in order to transport the workpiece carrier 600 between the individual processing stations.

In the direction of the process flow, a further processing station 720 is provided downstream of the loading station 710, which further processing station 720 serves to fill the pouch battery cell housings 109 located in the workpiece carrier 600 with electrolyte liquid and can therefore be referred to as a filling station. In the filling station 720, a filling system with movable filling lances is provided, which can be guided through the openings or recesses 112b of the crossbars 112 of the carrier devices 105 or 500 for filling the pouch battery cell housings 109, as has already been described above. Since the engagement mechanisms of the carrier devices 105 of the workpiece carrier 600 are already in their filling position when they arrive at the filling station 720, filling can take place without the engagement mechanisms first having to be moved to a different rest position. After the filling process, however, an actuator of the filling station 720 can be used to bring the engagement mechanisms into their closing position by actuating the configuration converter mechanisms 100 of the workpiece carrier 600, because it is now no longer necessary to keep the filling openings open by the engagement elements 112a.

A third processing station 730 serves to close the filling openings of the pouch battery cell housings 109 previously filled in the filling station 720, for which purpose, at each of the carrier devices 105, a sealing tool of the processing station 730 is used. This processing station 730 can thus be referred to as a closing station. It also has an actuator 731, which is used to transfer, by actuating the configuration converter mechanisms 100 of the carrier devices 105, the engagement mechanisms of the carrier devices 105 back to their respective loading and unloading positions after the filling openings have been closed.

In accordance with one variant of the process, the workpiece carrier 600 can now be transported back to the first processing station 710 and can be unloaded there, so that this results in a closed process loop. In this case, the processing station 710 serves both as a loading station and as an unloading station. In particular, after unloading, a new set of pouch battery cell housings 109 to be processed can be loaded into the workpiece carrier 600.

In accordance with another variant of the process, the processing station 710 is only used for loading, while a separate processing station 750 is provided for unloading. The latter can optionally also have an actuator 751 for actuating the configuration converter mechanisms 100 of the workpiece carrier 600. However, this is only necessary if the configuration of the carrier devices 105 of the workpiece carrier 600 is to be changed at this stage, which may be the case in particular if the engagement mechanisms of the carrier device 105 are not already in the loading and unloading position when they arrive at the processing station 750.

One or more further processing stations may be provided between the processing stations 730 and 750 or 710, respectively. In particular, this may be a processing station 740 (test station) for testing the pouch battery cell housings 109 which have already been sealed, for example within the framework of an optical inspection. Since it may be possible in some cases that an adjustment of the position of the engagement mechanisms of the carrier devices 105 needs to be carried out, the test station 740 may optionally also have an actuator 741 for actuating the configuration converter mechanisms 100 of the workpiece carrier 600.

Finally, as part of the process, even in the case of at least one of the processing stations 740 and 750 being used, the workpiece carrier is returned to the first processing station 710 at the end of the process in order for a new process run to be able to be started.

While at least one example embodiment has been described above, it is to be noted that a large number of variations thereto exist. In this context it is also to be noted that the example embodiments described herein only represent non-limiting examples, and that it is not intended thereby to limit the scope, the applicability, or the configuration of the devices and methods described herein. Rather, the preceding description will provide the person skilled in the art with instructions for the implementation of at least one example embodiment, whereby it is to be understood that various changes in the functionality and the arrangement of the elements described in an example embodiment can be made without thereby deviating from the subject matter respectively set forth in the appended claims as well as legal equivalents to this subject matter.

1.-20. (canceled)

21. A carrier device for carrying a pouch battery cell housing during a process of manufacturing a pouch battery cell, wherein the carrier device comprises:
a holder for holding the pouch battery cell housing; and
a configuration converter mechanism for a mechanical component, wherein the configuration converter mechanism comprises:
a locking tensioning mechanism with a first partial region and a second partial region, wherein
the first partial region is supported so as to be movable, by way of a translatory movement, with respect to the second partial region;
the second partial region is supported so as to be movable, by way of a rotational movement, with respect to the first partial region about a first axis of rotation and, as part of this, can be transferred, by movements which include a rotation about the first axis of rotation, between different rest positions of the second partial region, which follow one another along a fixed direction of rotation and each of which are mechanically stable; and
the locking tensioning mechanism is set up to convert a translatory movement of the first partial region brought about by action of an external force on the first partial region into a corresponding movement of the second partial region by a force coupling between the first and second partial regions, which movement of the second partial region is a rotation about the first axis of rotation in the fixed direction of rotation, and which transfers the second partial region from its current rest position into a subsequent rest position in accordance with the direction of rotation; and
a component which can be transferred between different mechanical configurations and which is coupled to the second partial region in a force-coupling manner in such a way that the transfer of the second partial region between two different successive rest positions brought about by the movement of the first partial region transfers the component between two different mechanical configurations of the component which correspond to the two different successive rest positions of the second partial region by carrying out a movement of at least one portion of the component, which is a rotation about a second axis of rotation which is different from the first axis of rotation;
wherein the component of the configuration converter mechanism has an engagement mechanism which, in one configuration, has a loading and an unloading position and, in another configuration, a filling position, between which it can be transferred by the configuration converter mechanism; and
wherein in the loading and unloading position, loading and unloading of the holder with the pouch battery cell housing is made possible by clearing a loading and unloading path for the pouch battery cell housing that is required for this purpose, and
wherein in the filling position, at least one engagement element of the engagement mechanism is introduced into the loading and unloading path in such a way that the at least one engagement element engages, or can engage, in a filling opening of a pouch battery cell housing that may be held by the holder.

22. The carrier device of claim 21, wherein:
the engagement mechanism furthermore has a third configuration and the configuration converter mechanism has a third rest position of the second partial region, which third rest position corresponds to the third configuration; and
in the third configuration, the engagement mechanism has a third position that is different from the loading and unloading position and different from the filling position, so that when the configuration converter mechanism is actuated at least three times, these three positions of the engagement mechanism are passed through sequentially.

23. The carrier device of claim 22, wherein, in the third configuration, the engagement mechanism assumes a position in which the or each engagement element is moved out of the loading and unloading path and exposes the filling opening of a pouch battery cell housing which may be held in the holder.

24. The carrier device of claim 21, wherein the engagement mechanism comprises a crossbar which can be transferred between the different configurations of the engagement mechanism by the configuration converter mechanism and from which crossbar the at least one engagement element extend as projections.

25. The carrier device of claim 24, wherein the engagement mechanism comprises at least two engagement elements, between which there is a recess or opening in the crossbar (112), through which recess or opening, in the filling position of the component, an access to the filling opening of the pouch battery cell housing, which pouch battery cell housing may be held in the holder, is enabled.

26. The carrier device of claim 21, wherein the holder has an adjustment option to adapt it to different formats of pouch battery cell housings.

27. The carrier device of claim 21, wherein the locking tensioning mechanism is furthermore set up in such a way that, for each of the rest positions of the second partial region, there is a corresponding mechanically stable rest position of the first partial region, in which the first partial region is held due to the force coupling between the first and second partial regions when the second partial region is in its corresponding rest position, wherein the rest positions of the first partial region differ from one another for different corresponding rest positions of the second partial region.

28. The carrier device of claim 21, wherein the locking tensioning mechanism comprises:
the first partial region, constructed in a tubular form with an interior space of the tubular form which interior space extends along a direction of translation;
the second partial region, comprising a wing arrangement with at least one wing member which extends transversely to the direction of translation;
a motion link body having a tubular form, in which the first partial region is supported so as to be movable in a translatory manner along the direction of translation which coincides with the first axis of rotation, wherein:
a groove or a slot-shaped opening in a wall of the motion link body cooperates with a lateral projection of the first partial region along the direction of translation in accordance with a principle of a motion link guide;
the motion link body has a sawtooth-like contour at its end which faces towards the second partial region, wherein a minima of the sawtooth-like contour lying between each two adjacent teeth of the contour define the rest positions of the second partial region;
a shaft which is supported in the interior space of the tubular form of the first partial region, which shaft is force-coupled both to the second partial region and to the component, to convey the force coupling between the first and second partial regions along the direction of translation; and
a first spring to press the second partial region with its wing arrangement against the sawtooth-like contour of the motion link body; so that the locking tensioning mechanism is configured in such a way that, when an external force acts on the first partial region along the direction of translation, the first partial region, guided by the motion link guide with the shaft as a conveyor of the force, displaces the second partial region along the direction of translation against a spring force of the first spring, to transfer the wing arrangement out of a rest position defined by the contour and then, after the external force has ceased, due to a rotational movement of the second partial region caused by an interaction of the wing arrangement with the sawtooth-like contour, as well as the spring force of the first spring, into a subsequent rest position of the second partial region along the direction of rotation, which subsequent rest position corresponds to a corresponding position of the shaft along the direction of translation and thus to a configuration of the component corresponding to this position.

29. The carrier device of claim 28, further comprising a second spring for the force coupling between the first partial region and the shaft to be provided through the second spring along the direction of translation.

30. The carrier device of claim 28, further comprising a housing for accommodating the locking tensioning mechanism, at least in part.

31. The carrier device of claim 30, wherein the housing comprises:
a first housing part with a pot-shaped or tubular base body, in the interior space of which the locking tensioning mechanism is accommodated, at least in part, and which base body is firmly connected to the motion link body; and
a second housing part which is connected to the first partial region to couple the external force to the first partial region and which second housing part surrounds the first housing part, at least in part, in such a way that the second housing part can be displaced with respect to the first housing part along the direction of translation.

32. A workpiece carrier for simultaneously carrying a plurality N of pouch battery cell housings during a process for a production of up to N pouch battery cells, wherein the workplace carrier comprises carrier devices of claim 21 each with a carrier structure which carries N devices fixed thereto or integrally formed therewith, in such a way that these devices can be operated simultaneously to carry up to N pouch battery cell housings, which may be held by a respective holder of an associated one of the devices, during the process.

33. A system for processing a plurality of pouch battery cell housings within a framework of a process for manufacturing pouch battery cells, wherein the system comprises a plurality of processing stations to be passed through sequentially for processing the pouch battery cell housings; and
wherein the system is configured to use the workpiece carrier of claim 32 both during the processing of the pouch battery cell housings in the individual processing stations, and for transferring the pouch battery cell housings between the processing stations within the framework of the process of handling the pouch battery cell housings.

34. The system of claim 33, wherein at least one of the processing stations comprises one or more actuators, by which, when they are actuated once or several times, a respective force can be exerted on the respective first partial regions of each of the carrier devices of the workpiece carrier, to set a predetermined configuration, assigned to the respective processing station, of the respective engagement mechanism of each of the carrier devices of the workpiece carrier.

35. The system of claim 34, wherein at least one of said processing stations comprises a suction mechanism which is configured, while the workpiece carrier is located at or in said processing station, to apply suction to at least one side wall of a pouch battery cell housing which may be present in the holder of one of the carrier devices, to open, or keep open, a filling opening of the pouch battery cell housing, so that by actuating the actuator or actuators, the engagement mechanism of the carrier device can be brought into a position in which at least one of the engagement elements of the engagement mechanism engages, or can engage, in the filling opening.

36. The system of claim 33, wherein one of the processing stations is configured for loading and unloading pouch battery cell housings respectively into, or out of, the holders of the carrier devices of the workpiece carrier while the engagement mechanisms of the carrier devices are respectively in the loading and unloading position.

37. The system of claim 33, wherein at least one of the processing stations is configured to fill any pouch battery cell housings which may be present in the workpiece carrier, which are each held by the holder of an associated one of the carrier devices of the workpiece carrier, with an electrolyte liquid, with the aid of a filling lance, while the engagement mechanisms of the carrier devices of the workpiece carrier are in their respective filling position.

38. The system of claim 33, wherein at least one of the processing stations is configured to close any pouch battery cell housings which may be present in the workpiece carrier and which are each held by the holder of an associated one of the carrier devices of the workpiece carrier, after they have previously been filled with an electrolyte liquid, to seal their filling openings, while the engagement mechanisms of the carrier devices of the workpiece carrier are each in a position which is different from the filling position.
